(19) United States
(12) Patent Application Publication
(10) Pub. No.: US 2010/0015475 A1
(43) Pub. Date: Jan. 21, 2010

(54) SOLID POLYMER FUEL CELL AND METHOD FOR ACTIVATING SAME

(76) Inventors: Sreekumar Kurungot, Aichi-ken (JP); Hirokazu Ishimaru, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/439,065

(22) PCT Filed: Aug. 31, 2007
(86) PCT No.: PCT/IB07/02504

§ 371 Date: Feb. 26, 2009

(30) Foreign Application Priority Data
Sep. 1, 2006 (JP) 2006-237113

(51) Int. Cl. H01M 8/04

(52) U.S. Cl. 429/13

(57) ABSTRACT

A solid polymer fuel cell has a catalyst layer including a nanohorn aggregate as a catalyst carrier, catalyst metal supported on the catalyst carrier, and a polymer electrolyte coating the catalyst carrier. Voltage higher than the open circuit voltage of the solid polymer fuel cell is applied to the catalyst layer so as to increase triphasic interfaces at which the reaction gas reduced at the catalyst layer, the catalyst metal, and the polymer electrolyte meet.

### BACKGROUND OF THE INVENTION

1. Field of the Invention

The invention relates to a solid polymer fuel cell and a method for activating a solid polymer fuel cell.

2. Description of the Related Art

Solid polymer fuel cells having polymer electrolyte membranes can be easily made compact and lightweight, and therefore their utilization as power sources for vehicles, such as electric vehicles, and small cogeneration systems, and the like, has been anticipated.

The electrode reactions at the catalyst layers of the anode and the cathode of a solid polymer fuel cell progress in triphasic interfaces (will be referred to also as “reaction sites” where appropriate) that are where the respective reaction gases, catalyst, and fluorine-containing ion-exchange resin (electrolyte) meet. Therefore, generally, catalyst layers in solid polymer fuel cells are made of, as their material, carbon blacks having a relatively larger specific surface area, carrying catalyst metal (e.g., platinum) and coated by fluorine-containing ion-exchange resin. This fluorine-containing ion-exchange resin may either be the same as or different from that of which the polymer electrolyte membranes are made.

Thus, at the anode, protons and electros are produced in the presence of the three elements, catalyst, carbon particles, and electrolytes. That is, reduction of hydrogen gas occurs in the presence of electrolyte, which has a proton conductivity, carbon particles, which have an electron conductivity, and catalyst. Therefore, the larger the amount of catalyst supported on the carbon particles, the higher the power generation efficiency. The same applies to the cathode. However, because catalyst for fuel cells is made of precious metal (e.g., platinum), increasing the catalyst supported on carbon particles increases the production cost of fuel cells significantly.

Typically, catalyst layers are produced by preparing an ink by dispersing electrolyte (e.g., Nafion (registered trademark)) and a catalyst powder (e.g., platinum powder and carbon powder) in a solution and casting and drying the ink. The particles of the catalyst powder measure several nm to several tens of nm, therefore they get into the deep inside of the pores of each carbon carrier. On the other hand, because the molecules of electrolyte polymers are large in size and also they are aggregate, they can not get into the nanosize pores, and therefore it is considered that the electrolyte polymers cover only the surface of the catalyst. Thus, the catalyst powder, such as a platinum powder, in the pores of the catalyst carriers does not contact the electrolyte polymers sufficiently, and such an inefficient use of the catalyst powder may reduce the performance of the catalyst.

In view of this, Japanese Patent Application Publication No. 2002-373662 (JP-A-2002-373662) recites a fuel cell electrode producing method for improving the power generation efficiency without increasing the amount of catalyst supported on carbon particles. In this method, an electrode paste containing a mixture of particles carrying catalyst particles and ion-conductive polymers is treated using a solution containing catalyst metal ions so that the catalyst metal ions are made ion-conductive polymers through ion substitution, and then the catalyst metal ions are reduced.

Meanwhile, International Application Publication WO2002/075831 describes electrodes for solid polymer fuel cells and solid polymer fuel cells having the same electrodes. The electrodes described in this publication are solid polymer electrolyte-catalyst composite electrodes composed of carbon particles carrying solid polymer electrolytes and catalytic substances. In these electrodes, monolayer carbon nanohorn aggregates are used as carbon particles. Each monolayer carbon nanohorn aggregate consists of monolayer carbon nanohorns (CNH) aggregating in a spherical shape. Carbon nanohorns are peculiarly structured carbon nanotubes having a conical end.

WO2002/075831 mentions “When the aggregates are used as the carbon substances to constitute the solid polymer electrolyte-catalyst combined electrode, there may be provided secondary aggregates obtained by aggregating a plurality of the aggregates. Pores each having a size of several nm to tens nm exist between the secondary aggregates, Therefore, the combined electrode will have a porous structure. The pores effectively contribute to the channel of the reaction gas such as oxygen and hydrogen. When the secondary aggregates are formed, the catalytic material can be carried at the inside of the secondary aggregates, and the solid polymer electrode can penetrate into the inside of the secondary aggregates, thereby providing excellent catalytic efficiency”, WO2002/075831 also mentions “At least a part of the carbon molecule aggregates or the carbon nano-horn aggregates 10 has an incomplete part. The term “incomplete part” herein means a broken structural part. For example, a carbon-carbon bond in a six-member ring is partly cut, or a carbon atom therein is lost, which constitutes the carbon molecule or the carbon nano-horn 5. A vacancy or a bond with other kind of a molecule may be formed. The above-mentioned incomplete part may be large, i.e., a hole in the carbon six-member ring. Each of them herein refers the “micropore”. The micropore may have, but not especially limited thereto, diameter of 0.3 to 5 nm”.

Further, Japanese Patent Application Publication No. 2004-152489 (JP-A-2004-152489) describes a technology for improving the usage rate of catalyst of catalyst electrodes of fuel cells in which carbon nanohorns are used as carbon material for forming catalyst-carrying carbon particle layers. According to this technology, a metal salt solution and carbon nanohorn aggregates are mixed, and a reducing agent is then added to the mixture and stirred, so that catalyst metal is supported on the surface of each carbon nanohorn aggregate, and reduction is then preformed at a low temperature, whereby the diameter of catalyst metal particles is controlled.

Further, Japanese Patent Application Publication No. 2006-40869 (JP-A-2006-40869) describes a typical aging method for aging direct methanol fuel cells. In this aging method, a fuel cell is energized such that current flows between the anode electrode and the cathode electrode in the same direction as it flows during power generation of the fuel cell. This energization is carried out by supplying an anode medium (e.g., methanol solution) to the anode electrode while supplying a cathode electrode (e.g., air) to the cathode electrode.

However, even if fuel cells are produced using the production method described in No. JP-A-2002-373662, or the like, the improvement of the power generation efficiency is limited. This is because there are nano-ordered pores in the catalyst carrying carbons that are too small for polymer electrolytes (i.e., polymer aggregates) to enter. That is, the catalyst, such as platinum, adsorbed in the deep inside of the pores is not used to form the aforementioned triphasic interfaces, that is, the aforementioned reaction sites.

Next, reference is made to WO2002/075831 reciting solid polymer fuel cell electrodes and solid polymer fuel cells having the same electrodes. In the electrodes described in this publication, carbon nanohorn aggregates are used as carbon carriers. However, there are acute gaps between the carbon nanohorns of each carbon nanohorn aggregate, and therefore, if catalyst (e.g., platinum) is adsorbed at the deep inside of the gaps, polymer electrolytes (i.e., polymer aggregates) do not contact such catalyst because they can not enter the gaps. Thus, sufficient triphasic interfaces (reaction sites) can not be produced, and therefore there is still a room for improving the power generation efficiency. Also, in WO2002/075831, “Pores each having a size of several nm to tens nm” only refers to the gaps between the secondary aggregates of the carbon nanohorn aggregates, and “The micropore may have diameter of 0.3 to 5 nm” only refers to the structural incompleteness of the six-member rings of carbon atoms. Thus, nothing in WO2002/075831 specifically addresses how to promote the forming of triphasic interfaces (reaction sites).

Further, Japanese Patent Application Publication No. 2004-152489 (JP-A-2004-152489) describes a technology that controls the diameter of catalyst metal particles supported on the surface of each carbon nanohorn aggregate. This publication recites that the average diameter of the catalyst particles is equal to or less than 5 nm. Further, this publication mentions “Although the average diameter of catalytic substance particles has been made 5 nm or less, it is preferably made 2 nm or less. By doing so, the specific surface area of the catalytic substance can be further reduced. As such, the usage efficiency of the catalyst improves and the output of the fuel cells increases accordingly. Although the lower limit of the particle diameter is not limited to any specific value, for example, it may be 0.1 nm or more, preferably 0.5 nm or more. In this way, electrodes achieving a high catalyst usage rate can be produced in a stable manner”. This recitation in JP-A-2004-152489 indicates a perception that the average diameter of catalytic substance should preferably be as small as possible. Further, JP-A-2004-152489 mentions “In order to improve the characteristics of the fuel cells, the catalyst activation at the catalyst electrodes needs to be enhanced by increasing the surface area of the catalytic substance. To achieve this, it is necessary to prepare catalyst particles having a small diameter and disperse them evenly”. In fact, in the corresponding embodiment of the technology described in this publication, platinum particles measuring 1 to 2 nm in an average diameter are used.

However, according to such technologies that use platinum particles measuring 1 to 2 nm, or less, in an average diameter, as in the case of the technology described in WO2002/075831, platinum particles, as catalyst particles, are adsorbed in the deep inside of acute gaps between carbon nanohorns of carbon nanohorn aggregates, and therefore polymer electrolytes (i.e., polymer aggregates) do not contact the platinum particles because they can not enter the gaps. Thus, triphasic interfaces (reaction sites) can not be sufficiently formed, and thereby there is still a room for improving the power generation efficiency.

As such, the foregoing technologies for promoting the forming of triphasic interfaces (reaction sites) have left a room for improving the power generation efficiency. Further, the aging method recited in JP-A-2006-40869 is a technology that addresses the necessity to reduce the initial running-in duration for direct methanol type fuel cells in order to cope with a problem that the power generation performance of direct methanol type fuel cells is low and unstable immediately after the fuel cells are assembled. That is, the aging method recited in JP-A-2006-40869 does not relate to catalyst layer structures.

### SUMMARY OF THE INVENTION

The invention provides a technology that, for the purpose of improving the catalyst efficiency, activates a catalyst layer including carbon nanohorns as catalyst carriers by applying voltage to the catalyst layer so that sufficient triphasic interfaces at which reaction gas, catalyst, and electrolyte meet are formed in the catalyst layer. Further, the invention enables efficient reactions at electrodes and thus improves the power generation efficiency of fuel cells.

The invention addresses how polymer electrolyte are entangled with carbon nanohorn aggregates of fuel cell electrode catalyst and addresses the gas permeability of polymer electrolyte. The invention, for the purpose of improving the catalyst efficiency, proposes to activate the catalyst layers by applying voltage thereto so that sufficient triphasic interfaces, which are where the reaction gases, the catalyst, and the electrolytes meet, are formed.

The above-described aspect of the invention relates to a method for activating a solid polymer fuel cell having a catalyst layer including a nanohorn aggregate as a catalyst carrier, catalyst metal supported on the catalyst carrier, and a polymer electrolyte coating the catalyst carrier. In this method, voltage higher than the open circuit voltage of the solid polymer fuel cell is applied to the catalyst layer.

The method according to the above-described aspect of the invention may be such that the voltage application to the catalyst layer is performed either before the solid polymer fuel cell is started up or while the operation of the solid polymer fuel cell is suspended.

The phrase “before the solid polymer fuel cell is started up” also encompasses the period from when the catalyst layer is formed to when the fuel cell is shipped out from the factory. That is, the activation voltage may be applied to the catalyst layer in the period from when the fuel cell is assembled to when it is shipped out from the factory.

Further, the method according to the above-described aspect of the invention may be such that the voltage applied to the catalyst layer is 1.23 to 2.0 V and the duration of the voltage application is 1 to 10 min.

Further, the method according to the above-described aspect of the invention may be such that the voltage is applied such that current flows in the sane direction as current flows during power generation of the solid polymer fuel cell.

Further, the method according to the above-described aspect of the invention may be such that the voltage is applied such that current flows in a direction opposite to the direction in which current flows during power generation of the solid polymer fuel cell.

This feature distinguishes the invention from typical aging during which current always flows in the same direction as it does during power generation of the fuel cells. That is, the invention addresses how polymer electrolytes are entangled with carbon nanohorn aggregates of fuel cell electrode catalyst and addresses the gas permeability of polymer electrolytes. Thus, the technical concept of the invention is different from that of aging that is normally performed as a running-in.

Further, the method according to the above-described aspect of the invention may be such that surface groups are produced on the surface of the carbon nanohorn aggregate by treating the carbon nanohorn aggregate using an oxygenated water beforehand, and then the catalyst metal is dispersed on the surface of the carbon nanohorn aggregate.

According to the invention, as described above, the catalyst layers formed on carbon nanohorns, which are used as catalyst carriers, are activated in advance by being energized at a voltage higher than the open circuit voltage of the fuel cell before the start of the operation of the fuel cell and/or during the suspension of the operation of the fuel cell. Thus, sufficient triphasic interfaces, which are where the reaction gas, the catalyst, and the electrolyte meet, can be formed, whereby the catalyst efficiency improves. As such, the electrode reactions progress efficiently, and thus the power generation efficiency of the fuel cell improves.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a view schematically showing how the electric resistance of a catalyst layer in which carbon nanohorns are used as catalyst carriers decreases as the catalyst layer is activated through voltage application;

FIG. 2 is a view schematically showing how the state of contact between the polymer electrolytes and the catalyst on the catalyst carrier improves as the catalyst layer, in which carbon nanohorns are used as the catalyst carriers, is activated through voltage application;

FIG. 3 illustrates how the reaction gas permeability improves as the catalyst layer on each carbon nanohorn is activated through voltage application;

FIG. 4 indicates a result of monitoring of the performance of the MEA;

FIG. 5 indicates the result of comparison between the correlation between the current density and the electric resistance of the MEA activated through voltage application and the same correlation obtained when no voltage was applied to the MEA, which comparison was made to assess the performance of the MEA;

FIG. 6 indicates the result of comparison between the correlation between the current density and the voltage of the MEA activated through voltage application and the same correlation obtained when no voltage was applied to the MEA, which comparison was made to assess the performance of the MEA;

FIG. 7 indicates the result of comparison between the correlation between the current density and the electric resistance of an MEA in which typical carbon carriers are used and which was activated through voltage activation and the same correlation when no voltage is applied to the MEA, which comparison was made to assess the performance of the MEA; and

FIG. 8 indicates the result of comparison between the correlation between the current density and the voltage of an MEA in which typical carbon carriers are used and which was activated through voltage activation and the same correlation when no voltage is applied to the MEA, which comparison was made to assess the performance of the MEA.

### DETAILED DESCRIPTION OF THE EMBODIMENTS

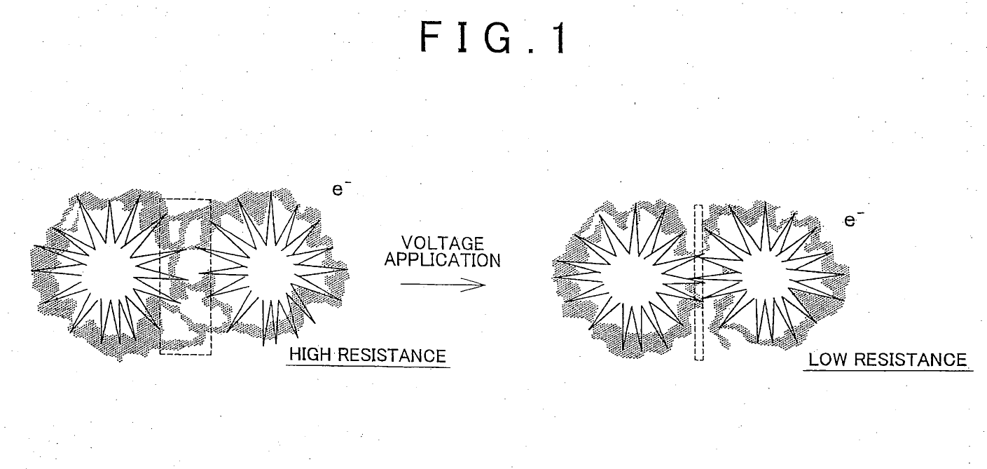

Hereinafter, the invention will be described with reference to the drawings schematically showing an electrode catalyst for solid polymer fuel cells according to the invention. Referring to FIG. 1 to FIG. 3, polymer electrolytes, which are typified by Nafion (registered trademark), are coated on catalyst carriers that are formed by carbon nanohorn aggregates on which catalyst metal (e.g., platinum) is supported (Pt/CNH).

FIG. 1 illustrates how the electric resistance of a catalyst layer in which carbon nanohorns are used as catalyst carriers decreases as the catalyst layer is activated through voltage application according to the invention. Before activated, the catalyst layer has a high electric resistance because of the network of polymer electrolytes. However, when voltage is applied to the catalyst layer, the distance between adjacent carbon nanohorns decreases and the network of polymer electrolytes breaks up, whereby the electric resistance of the catalyst layer decreases as a whole In this example of the invention, the applied voltage is equal to or higher than the open circuit voltage of the polymer electrolytes.

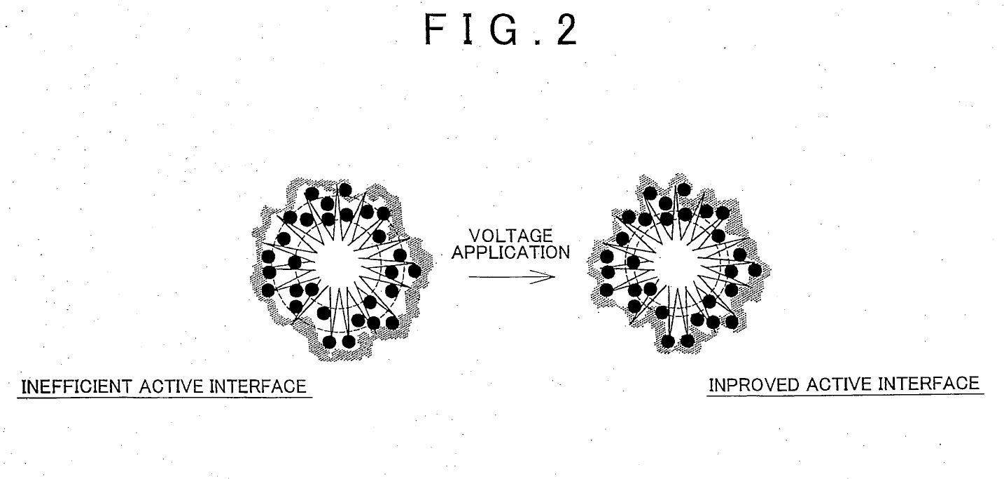

FIG. 2 illustrates how the state of contact between the polymer electrolytes and the catalyst on the catalyst carriers improves as the catalyst layer, in which carbon nanohorns are used as the catalyst carriers, is activated. As shown in the left side of FIG. 2, a deep contact between the catalyst and the polymer electrolytes is difficult due to their size mismatch. However, when voltage is applied, the network of the polymer electrolytes shrinks or structurally changes as shown in the right side of FIG. 2, whereby the contact between the catalyst and the polymer electrolytes improves. More specifically, before applying voltage, the polymer electrolytes, due to their viscosity, are present only at some parts of the surface of each carbon nanohorn. However, when voltage is applied, the polymer electrolytes enter between carbon nanotubes constituting each carbon nanohorn, so that the polymer electrolytes sufficiently contact the catalyst supported deep inside of the carbon nanohorn and thus sufficient triphasic interfaces are formed therein.

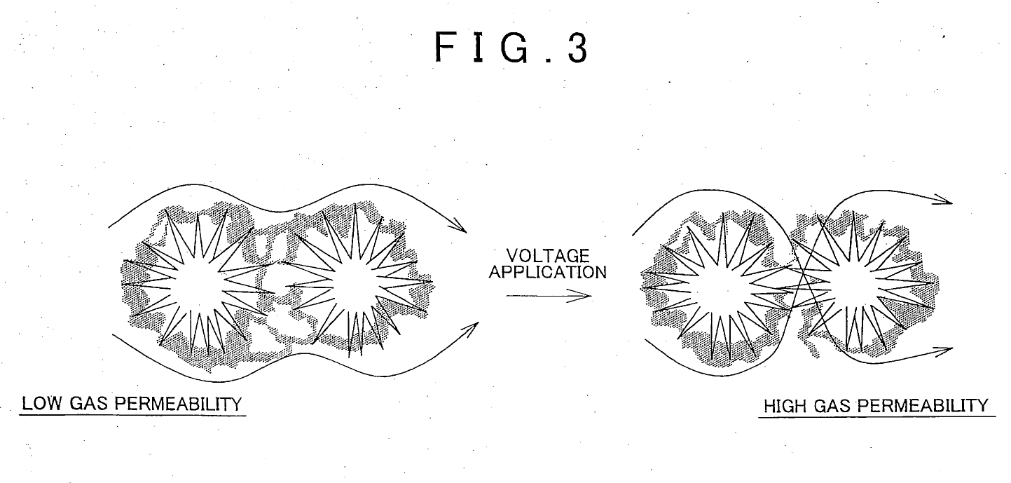

FIG. 3 illustrates how the reaction gas permeability improves as the catalyst layer on each carbon nanohorn is activated through the voltage application according to the invention. When voltage is not applied to the catalyst layer, the reaction gas permeability between carbon nanohorns is low due to the presence of the network of the polymer electrolytes. However, when voltage is applied to the catalyst layers, the network of the polymer electrolyte breaks up, so that the reaction gas permeability increases.

As shown in FIG. 1 to FIG. 3, respectively, “carbon nanohorn aggregates” on which catalyst metal is supported are round aggregates of carbon nanohorns. Note that carbon nanohorns are carbon isotopes consisting of carbon atoms only. The word “round” is herein intended to encompass, not only spherical shapes, but also various other shapes, such as oval sphere shapes, ring shapes, etc.

In this example of the invention, round carbon nanohorn aggregates are used as catalyst carriers for the catalyst layers of solid polymer fuel cells. Again, the word “round” is herein intended to encompass, not only spherical shapes, but also various other shapes, such as oval sphere shapes, ring shapes, etc.

Each carbon nanohorn aggregate is constituted of carbon nanohorns that are carbon nanotubes each having the shape of a tube with a conical portion at one end. The Van der Waals' force that acts between the conical portions of the carbon nanohorns brings them together such that the tube portions of the carbon nanohorns are located at the center of the aggregate while the conical portions stick out to the outside like “horns”. The diameter of each carbon nanohorn aggregate is equal to or less than 120 nm, typically from 10 to 100 nm.

The diameter of each carbon. nanohorn of the carbon nanohorn aggregate is approx. 2 nm, and its length is typically from 30 to 50 nm. The average inclination of the conical portions is 20°, as viewed in their axial cross sections. Thus peculiarly structured, the carbon nanohorn aggregates have a packing structure having a relatively larger specific surface area.

Typically, carbon nanohorn aggregates are produced by the laser ablation method in which solid carbon simple substances, such as graphite, are targeted in an inactive gas atmosphere and at the room temperature and at the pressure of 1. 01325×10⁵ Pa. The size of the pores formed between the round particles of the carbon nanohorn aggregates can be controlled by controlling the conditions of the production using the laser ablation method and by controlling the oxidizing process after production. At the center of each carbon nanohorn aggregate, carbon nanohorns are chemically bonded with each other. For example, the tube portions of the carbon nanohorns may be bonded in a round form at the center of each carbon nanohorn aggregate, or each carbon nanohorn aggregate may have a space at the center. However, the invention is not limited by the structure at the center of each carbon nanohorn aggregate.

The carbon nanohorns of the carbon nanohorn aggregates may be those whose tips are closed, those whose tips are not closed, or those whose tips are rounded. In the case where the carbon nanohorn aggregates are constituted of carbon nanohorns with rounded tips, the carbon nanohorns aggregate in a radial form such that the rounded tips face the outside. Further, the carbon nanohorns of the carbon nanohorn aggregates may have missing parts that serve as pores. Further, the carbon nanohorn aggregates may include carbon nanotubes as well as carbon nanohorns.

Each carbon nanohorn aggregate may be a monolayer carbon nanohorn aggregate that has a higher hydrogen-ion conductivity. Further, each carbon nanohorn aggregate may be a monolayer carbon nanohorn constituted of monolayer graphite nanohorns. In this case, the electric conductivity of the carbon nanohorn aggregates improves. As such, when such carbon nanohorn aggregates are used in catalyst electrodes of a fuel cell, the performance of the fuel cell improves.

The catalyst metal supported on the catalyst carriers for the catalyst layers of the solid polymer fuel cell according to the invention may be selected, for example, from among the following substances. First, the anode catalyst may be selected, for example, from among platinum, rhodium, palladium, iridium, osmium, ruthenium, rhenium, gold, silver, nickel, cobalt, lithium, lanthanum, strontium, and yttrium. Note that each of these substances may be used alone or two or more of them may be used in combination. These substances can be used also as the material of the cathode catalyst. Note that the anode catalyst and the cathode catalyst may either be made of a common material or different materials.

The polymer electrolytes in the solid polymer fuel cell having the catalyst layers according to the invention serve to electrically connect the solid electrolyte membranes and the carbon nanohorn aggregates carrying the catalyst metal and to enable the fuel to reach the surface of the catalyst metal. Thus, the polymer electrolytes are required to have a hydrogen ion conductivity. Further, in the case where an organic liquid fuel, such as methanol, is supplied to the anode, the anode is required to have a fuel permeability and the cathode is required to have an oxygen permeability. For the purpose of satisfying these requirements, a material having a high hydrogen-ion conductivity and a high organic-liquid-fuel conductivity (e.g., methanol) may be used as the material of the polymer electrolytes. For example, organic polymers having polar groups, such as strong acid groups (e.g., sulfonic acid groups, phosphate groups) and weak acid groups (e.g., carboxyl groups) may be used. Examples of such organic polymers include: sulfonic-group-containing perfluoro carbon (e.g., Nafion (Product of E. I. du Pont de Nemours and Company), Aciplex (Product of Asahi Kasei Corporation)); carboxyl-group-containing perfluoro carbon (e.g., Flemion S film (product of Asahi Glass. Co., Ltd.)); polystyrenesulfonic acid copolymers; polyvinylsulfonic acid copolymers; cross-linked alkylsulfonic acid derivatives; copolymers of fluorine-containing polymers composed of fluorine resin skeletons and sulfonic acids, or the like; and copolymers obtained by copolymerizing acrylamide (e.g., acrylamide-2-methylpropanesulfonic acid) and acrylate (e,g, n-butyl methacrylate).

Further, organic polymers having polar groups, such as strong acid groups and weak acid groups, may be used as polymer electrolytes. Other examples of polymers with which such polar groups can be bonded are: polybenzimidazole derivatives; polybenzoxazole derivatives; polyethylenimine cross-links; polysilamine derivatives; amine-substituted polystyrene (e.g., polydiethylaminoethylpolystyrene); resin having nitrogen or hydroxyl groups, such as nitrogen-substituted polyacrylate (e.g., diethylaminoethylpolymethacrylate); hydroxyl-group-containing polyacryl resin typified by silanol-containing polysiloxane and hydroxyetbylpolymethyl acrylate; and hydroxyl-group-containing polystyrene resin typified by p-hydroxypolystyrene.

Further, cross-linking substituents (e.g., vinyl groups, epoxy groups, acryl groups, methacryl groups, cinnamoyl groups, methylol groups, azido groups, and naphthoquinonediazido groups) may be introduced to the foregoing polymers as needed.

The fuel electrode and the oxidizer electrode may either be made of the same polymer electrolyte or different polymer electrolytes.

According to the invention, in terms of the usage efficiency of the catalyst, the ratio of the weight of the polymer electrolytes to the sum of the weight of the polymer electrolytes and the weight of the catalyst-carrying carbon nanohorn aggregates may be less than 10%.

According to the invention, further, in order to facilitate the supporting of the catalyst metal on the carbon nanohorn aggregates (catalyst carriers) and the coating of the polymer electrolytes, the carbon nanohorn aggregates may be treated using an oxygenated water beforehand. This pretreatment produces various surface groups on the surface of each carbon nanohorn. When catalyst metal (e.g., platinum) is dispersed in the presence of polyol, the surface groups promote the dispersing of the catalyst metal on the surface of each carbon nanohorn.

The technical advantages of treating the carbon nanohorn aggregates using an oxygenated water are, for example: (i) the oxygenated water prevents breakage of the carbon nanohorn structures; (ii) the oxygenated water oxidizes and thus removes amorphous impurities in the carbon nanohorns; and (iii) surface groups (e.g., hydroxyl groups, carboxylic acid groups, and carbonyl groups) are produced on the surface of each carbon nanohorn due to the oxygenated water.

Next, a method for producing catalyst layers of solid polymer electrolyte fuel cells according to the invention will be described. The catalyst metal may be supported on the carbon nanohorn aggregates using typical impregnation methods. One such method is that a colloidal catalytic substance, which has been obtained by dissolving or dispersing metallic salts of a catalytic substance in a solution, is first supported on carbon nanohorn aggregates, and the carbon nanohorn aggregates are then subjected to a reducing treatment. In the reducing treatment, the carbon nanohorn aggregates are reduced at the reducing temperature of 130° C. or higher. By doing so, the catalyst metal particles supported on the surface of each carbon nanohorn aggregate become relatively large spherical particles measuring 3.2 nm or more in an average diameter, and also the catalyst metal is evenly spread on each carbon nanohorn particle. Then, the carbon particles carrying the catalyst and polymer electrolyte particles are dispersed in a solution, whereby the solution turns into a paste. Then, the paste is applied to a substrate and then dried, whereby a fuel cell catalyst electrode is obtained.

Further, the carbon nanohorn aggregates may alternatively be supported, through a thermal treatment, onto carbon fibers, carbon nanofibers, carbon nanotubes, or the like. By doing so, catalyst layers having a desired fine structure can be obtained.

The method for applying the foregoing paste to the substrate is not limited to any specific method. For example, the paste may be applied using a brush, by being sprayed, or by a screen printing. The paste is applied in, for example, a thickness of 1 μm to 2 mm. After the paste has been applied to the substrate, it is then heated at a predetermined temperature and for a predetermined duration, both corresponding to the type of the fluorine resin used, whereby a fuel electrode or an oxidizer electrode is obtained. These heating temperature and heating duration are varied according to the material used. For example, the heating temperature may be set to 100 to 250 ° C. and the heating duration may be set to 30 sec to 30 minutes.

Hereinafter, solid polymer fuel cells having catalyst layers according to the invention will be described. In a solid polymer fuel cell, a solid electrolyte membrane is interposed between the anode and the cathode, which enables hydrogen ions and water molecules to move between the anode and the cathode. Membranes having a high hydrogen ion conductivity may be used as solid electrolyte membranes. Further, solid electrolyte membranes having a high chemical stability and a high mechanical strength may be used.

Organic polymers having polar groups, such as strong acid groups (e.g., sulfonic acid groups, phosphate groups, phosphone groups, phosphine groups) and weak acid groups (e.g., carboxyl groups) may be used as the material of solid electrolyte membranes. Examples of such organic polymers are: sulphonated poly (4-phenoxybenzoyl-1, 4-phenylene); aromatic-series-containing polymers (e.g., alkylsulfonated polybenzimidazole); polystyrenesulfonic acid copolymers; polyvinylsulfonic acid copolymers; cross-linked alkylsulfonic acid derivatives; copolymers such as fluorine-containing copolymers composed of fluorine resin skeletons and sulfonic acids; copolymers obtained by copolymerizing acrylamide (e.g., acrylamide-2-methylpropanesulfonic acid) and acrylate (e,g, n-butyl methacrylate); sulfonic-group-containing perfluoro carbon (Nafion (registered trademark, E. I. du Pont de Nemours and Company), Aciplex (registered trademark, Asahi Kasei Corporation); and carboxyl-group-containing perfluoro carbon (Flemion S film (registered trademark, Asahi Glass. Co., Ltd.))

The fuel supplied to the solid electrolyte fuel cell may either be a gaseous fuel or a liquid fuel. Hydrogen is one example of a gaseous fuel. Examples of a liquid fuel are fuels containing the following organic compounds: alcohol (e.g., methanol, ethanol, and propanol); ether (e.g., dimethyl ether); cyclopraffin (e.g., cyclohexane); cyclopraffin having hydrophilic groups, such as hydroxyl groups, carboxyl groups, amino groups, amide groups; and monosubstituted or disubstituted cyclopraffin. Note that the word “cyclopraffin” is herein intended to encompass cyclopraffin and its substitutions and it is selected from other than aromatic series compounds.

Thus, in the solid polymer fuel cells obtained as described above, carbon nanohorn aggregates are used as carbon particles carrying catalyst and the amount of the polymer electrolytes/the amount of the carbon nanohorn aggregates is made 0.32 to 0.70, whereby 0.005 to 0.1 μm pores are formed between the polymer electrolytes in each catalyst layer in the MEA (Membrane Electrode Assembly) of the fuel cell. As such, sufficient triphasic interfaces are formed, and the small amount of catalyst metal is efficiently used for reactions, so that the catalyst usage rate increases. In this way, the power generation efficiency can be improved without increasing the amount of material. In particular, the power generation characteristic in high current density regions can be improved.

Hereinafter, the solid electrolyte fuel cell having catalyst layers according to the invention will be described in more detail with reference to an example of the invention. However, it is to be noted that the invention is not limited to the following example.

High-purity carbon nanohorns were prepared, and chlorides, nitrides, organics, or the like, of Pt, Rh, Co, Cr, Fe, Ni, etc., were prepared as the metal source. Polyol and ethylene glycol were prepared. Surface groups are produced on the surface of each carbon nanohorn specimen by treating it using an oxygenated water. The supporting of the catalyst metal was carried out by Polyol process using low-surface-tension polyol. The amount of the platinum supported was Pt/CNH=0.40. Then, the specimen was reduced at 140° C. for 8 hours. After filtered and dried, the specimen was calcined at 100° C. in an inactive gas. Then, the obtained electrode catalyst was made an ink using a given method, and a catalyst layer for a MEA was formed by applying the ink using Cast method.

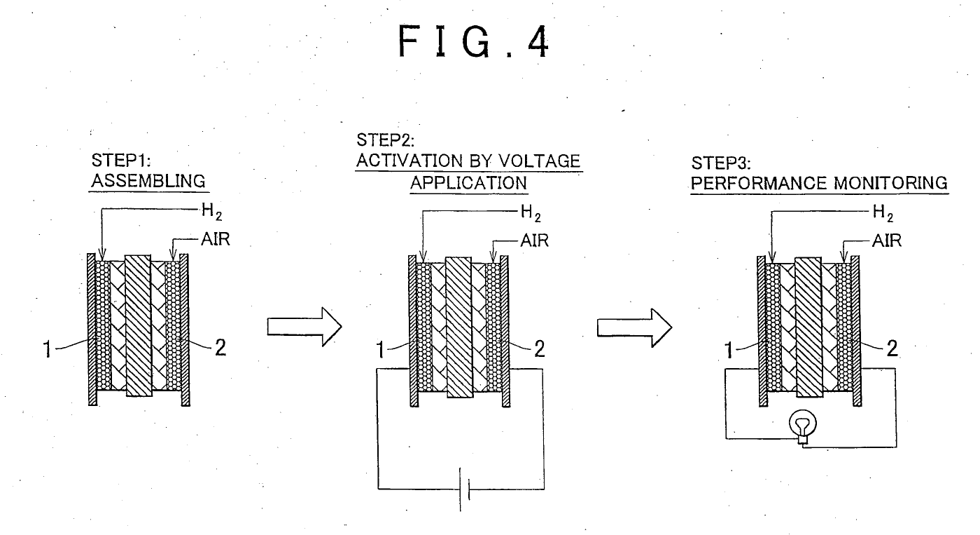

FIG. 4 indicates a result of monitoring of the performance of the MEA. During the monitoring, hydrogen gas is supplied to the anode 1 of the MEA and air is supplied to the cathode 2 such that a voltage of 1.5 V was generated between the anode 1 and the cathode 2 for 6 min. Note that the appropriate range of this voltage is 1. 23 V to 2.0 V and the appropriate duration for the voltage application is 1 to 10 mins (Step 1 and Step 2 in FIG. 4).

The correlation between the current density and the electric resistance of the MEA activated by the applied voltage was determined and compared with the same correlation obtained when no voltage was applied to the MEA. Likewise, the correlation between the current density and the voltage of the MEA activated by the applied voltage was obtained and compared with the same correlation obtained when no voltage was applied to the MEA (Step 3 in FIG. 4).

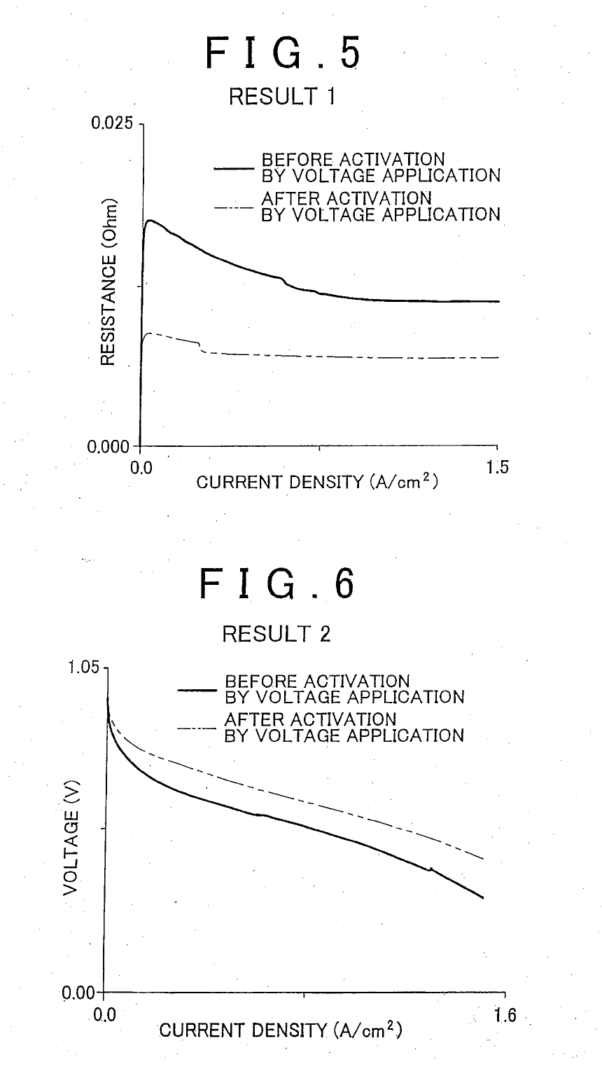

FIG. 5 indicates the result of comparison between the correlation between the current density and the electric resistance of the MEA activated by the applied voltage and that obtained when no voltage was applied to the MEA. This comparison, as indicated in FIG. 5, made it clear that the invention reduces the electric resistance significantly.

FIG. 6 indicates the result of comparison between the correlation between the current density and the voltage of the MEA activated by the applied voltage and that obtained when no voltage was applied to the MEA. This comparison, as indicated in FIG. 6, made it clear that the invention improves the power generation performance of the fuel cell significantly.

Further, the same voltage application was performed to an MEA in which typical carbons were used as catalyst carriers in place of carbon nanohorn aggregates, and the obtained effects were studied. In this trial, more specifically, Ketjen (product name), which is typically used as carbon carriers, was used in place of carbon nanohorn aggregates, and the correlation between the current density and the electric resistance of the MEA activated by the applied voltage was obtained and compared with the same correlation obtained when no voltage is applied to the MEA.

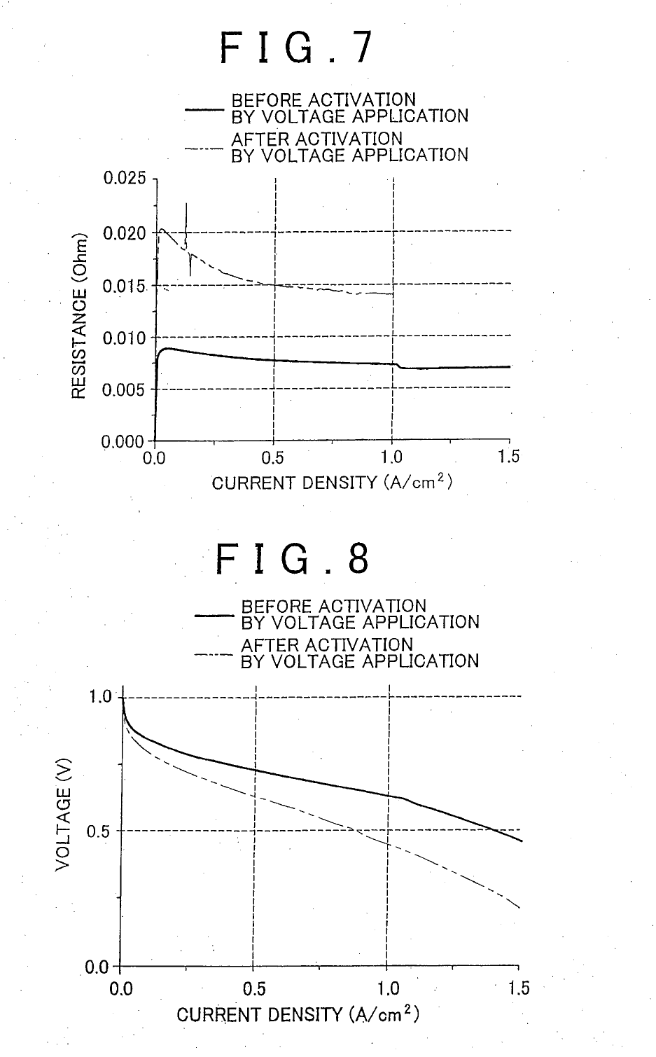

FIG. 7 indicates the result of comparison between the correlation between the current density and the electric resistance of the MEA in which Ketjen (product name) is used and which was activated through the voltage application and the same correlation obtained when no voltage is applied to the MEA. This comparison made it clear that the electric resistance significantly increases when voltage is applied, as opposed to the result of the example of the invention.

FIG. 8 indicates the result of comparison between the correlation between the current density and the voltage of the MEA in which Ketjen (product name) is used and which was activated by voltage application and the same correlation when no voltage is applied to the MEA. This comparison made it clear that the power generation performance of the fuel cell significantly deteriorates when voltage is applied, as opposed to the result of the example of the invention.

As such, the foregoing catalyst activation method is effective only for catalyst layers in which carbon nanohorns are used as catalyst carriers.

According to the invention, as described above, the catalyst layers formed on carbon nanohorns that are used as catalyst carriers are activated in advance by being energized at a voltage higher than the open circuit voltage of the fuel cell before the fuel cells is started up or during the suspension of the operation of the fuel cell. Thus, sufficient triphasic interfaces, which are where the reaction gases, the catalyst, and the electrolytes meet, can be obtained, whereby the catalyst efficiency improves. As such, the reactions at the respective electrodes progress efficiently, and thus the power generation efficiency of the fuel cell improves. Accordingly, the invention contributes to putting fuel cells into a practical use and promoting their proliferation.

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1. A method for activating a solid polymer fuel cell having a catalyst layer including a nanohorn aggregate as a catalyst carrier, catalyst metal supported on the catalyst carrier, and a polymer electrolyte coating the catalyst carrier, the method comprising:
applying a voltage higher than the open circuit voltage of the solid polymer fuel cell to the catalyst layer.

2. The method according to claim 1, wherein
the voltage application to the catalyst layer is performed either before the solid polymer fuel cell is started up or while the operation of the solid polymer fuel cell is suspended.

3. The method according to claim 1, wherein the voltage applied to the catalyst layer is 1.23 to 2.0 V and the duration of the voltage application is 1 to 10 min.

4. The method according to claim 1, wherein
the voltage is applied such that current flows in the same direction as current flows during power generation of the solid polymer fuel cell.

5. The method according to claim 1, wherein
the voltage is applied such that current flows in a direction opposite to the direction in which current flows during power generation of the solid polymer fuel cell.

6. The method according to claim 1, wherein
surface groups are produced on the surface of the carbon nanohorn aggregate by treating the carbon nanohorn aggregate using an oxygenated water beforehand, and then the catalyst metal is dispersed on the surface of the carbon nanohorn aggregate.
